(19) United States
(12) Patent Application Publication
(10) Pub. No.: US 2015/0314643 A1
(43) Pub. Date: Nov. 5, 2015

(54) CONTROLLED CONTACT TURF WHEEL FOR TURF-CARE VEHICLE

(71) Applicant: Textron, Inc., Providence, RI (US)

(72) Inventor: Linton Linn Lewis, Rock Hill, SC (US)

(73) Assignee: Textron, Inc., Providence, RI (US)

(21) Appl. No.: 14/265,626

(22) Filed: Apr. 30, 2014

(51) Int. Cl. B60B 33/00; A01D 34/81; A01D 34/82; A01D 34/00

(52) U.S. Cl. CPC B60B 33/0028; A01D 34/00; A01D 34/81; A01D 34/82; B60B 33/0036

(57) ABSTRACT

The present disclosure provides a controlled contact turf wheel for a turf-care vehicle, wherein the controlled contact turf wheel comprises a plurality of annular ground contact ribs, a plurality of annular grass passage channels disposed between the ribs. The controlled contact turf wheel is structured and operable to allow grass to pass through the channels as the controlled contact turf wheel rolls across the ground without flattening, compressing or compacting the grass against the ground, thereby minimizing residual uncut/partially cut wheel lines in the cut path of the turf-care vehicle.

### FIELD

The present teachings relate to turf-care vehicles, and more particularly to wheels and/or tires for such vehicles that are structured to eliminate marks and/or lines from being made in the cut path of the vehicle resulting from flattening, compression or compaction of grass by the wheels and/or tires as the vehicle traverses the ground.

### BACKGROUND

The statements in this section merely provide background information related to the present disclosure and may not constitute prior art.

Commercial turf-care vehicles typically used for cutting, grooming and maintaining grass at golf courses, sporting venues, parks, consumer lawns, etc., often include one or more mower decks that each include a blade that is rotated a high rate of speed to cut the grass as the vehicle traverses ground. Often, as such turf-care vehicles, e.g., multi-deck mowers, traverse the ground, the wheels of the mower decks and/or the tires of the vehicle flatten, compress or compact the uncut grass, i.e., press the uncut grass down, prior to the grass passing under, and being cut by, the rotating blades of the mower decks. Subsequently, the flattened/compressed/compacted grass does not spring back to its original orientation and/or is not drawn into an upright orientation by operation of the mower deck prior to passing under the rotating blades of the mower decks. Consequently, the flattened/compressed/compacted grass is not cut, or is not cut to the same length as the surrounding grass that is not flattened/compressed/compacted by the mower deck wheels and/or vehicle tires.

Thus, the longer flattened/compressed/compacted grass will produce an uneven grass top surface resulting in visible lines or swaths, referred to herein as residual uncut/partially cut wheel lines, in the cut path of the vehicle. Still further, in the days that follow the cutting, the flattened/compressed/compacted grass tends to spring back up accentuating the residual uncut/partially cut wheel lines and making them more visible. Such residual uncut/partially cut wheel lines created in the cut path of turf-care vehicles have been a persistent problem in professional and consumer turf-care for many years.

### SUMMARY

In various embodiments, the present disclosure provides a controlled contact turf wheel for a turf-care vehicle, wherein the controlled contact turf wheel comprises a plurality of annular ground contact ribs, a plurality of annular grass passage channels disposed between the ribs. The controlled contact turf wheel is structured and operable to allow grass to pass through the channels as the controlled contact turf wheel rolls across the ground without flattening, compressing or compacting the grass against the ground, thereby minimizing residual uncut/partially cut wheel lines in the cut path of the turf-care vehicle.

In various other embodiments, the present disclosure provides a controlled contact turf wheel assembly for a turf-care vehicle, wherein the controlled contact turf wheel assembly comprises an axle and a controlled contact turf wheel disposed on the axle. The controlled contact turf wheel comprises a plurality of annular ground contact ribs, a plurality of annular grass passage channels disposed between the ribs. The controlled contact turf wheel is structured and operable to allow grass to pass through the channels as the controlled contact turf wheel rolls across the ground without flattening, compressing or compacting the grass against the ground, thereby minimizing residual uncut/partially cut wheel lines in the cut path of the turf-care vehicle. The controlled contact turf wheel assembly can additionally include a wheel cleaning device structured and operable to prevent debris from accumulating in the channels as the controlled contact turf wheel rolls across a ground surface with which the controlled contact turf wheel is in contact.

In various other embodiments, the present disclosure provides a mower deck for a turf-care vehicle, wherein the mower deck comprises a frame and at least one controlled contact turf wheel assembly mounted to the frame. In such embodiments, the controlled contact turf wheel assembly comprises an axle and a controlled contact turf wheel disposed on the axle. Moreover, the controlled contact turf wheel comprises a plurality of annular ground contact ribs, a plurality of annular grass passage channels disposed between the ribs. The controlled contact turf wheel is structured and operable to allow grass to pass through the channels as the controlled contact turf wheel rolls across the ground without flattening, compressing or compacting the grass against the ground, thereby minimizing residual uncut/partially cut wheel lines in the cut path of the turf-care vehicle. In various implementations, the controlled contact turf wheel assembly can additionally include a wheel cleaning device structured and operable to prevent debris from accumulating in the channels as the controlled contact turf wheel rolls across a ground surface with which the controlled contact turf wheel is in contact.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an isometric view of a turf-care vehicle including at least one controlled contact turf wheel, in accordance with various embodiments of the present disclosure.

FIG. 2 is a front view of an exemplary controlled contact turf wheel shown in FIG. 1, in accordance with various embodiments of the present disclosure.

FIG. 3A is an isometric view of a controlled contact turf wheel assembly including the controlled contact turf wheel shown in FIGS. 1 and 2 and debris clearing pins, in accordance with various embodiments of the present disclosure.

FIG. 3B is an isometric view of the controlled contact turf wheel assembly shown in FIG. 3A configured as a caster wheel, in accordance with various embodiments of the present disclosure.

FIG. 3C is an isometric view of a controlled contact turf wheel assembly including the controlled contact turf wheel shown in FIGS. 1 and 2 and a debris clearing pins, in accordance with various other embodiments of the present disclosure.

FIG. 4 is an isometric view of a portion of a mower deck shown in FIG. 1 comprising a fixed controlled contact turf wheel assembly including the controlled contact turf wheel shown in FIGS. 1 and 2, and including the caster wheel assembly shown in FIG. 3C, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

As described above, when known turf-care vehicles traverse the ground while cutting the grass, irregularities in the grass cut height are commonly caused by the mower deck wheels and/or tires of the turf-care vehicle flattening, compressing and/or compacting of the grass prior to the mower decks, and the corresponding rotating grass cutting blades, of the turf-care vehicle passing over the grass. As a result, the flattened, compressed and/or compacted grass is not cut the same height as the surrounding non-flattened, non-compressed, non-compacted grass, thereby creating residual lines of irregular height cut grass in the cut path of the turf-care vehicle. These residual lines of irregular height cut grass are simply referred to herein as residual uncut/partially cut wheel lines.

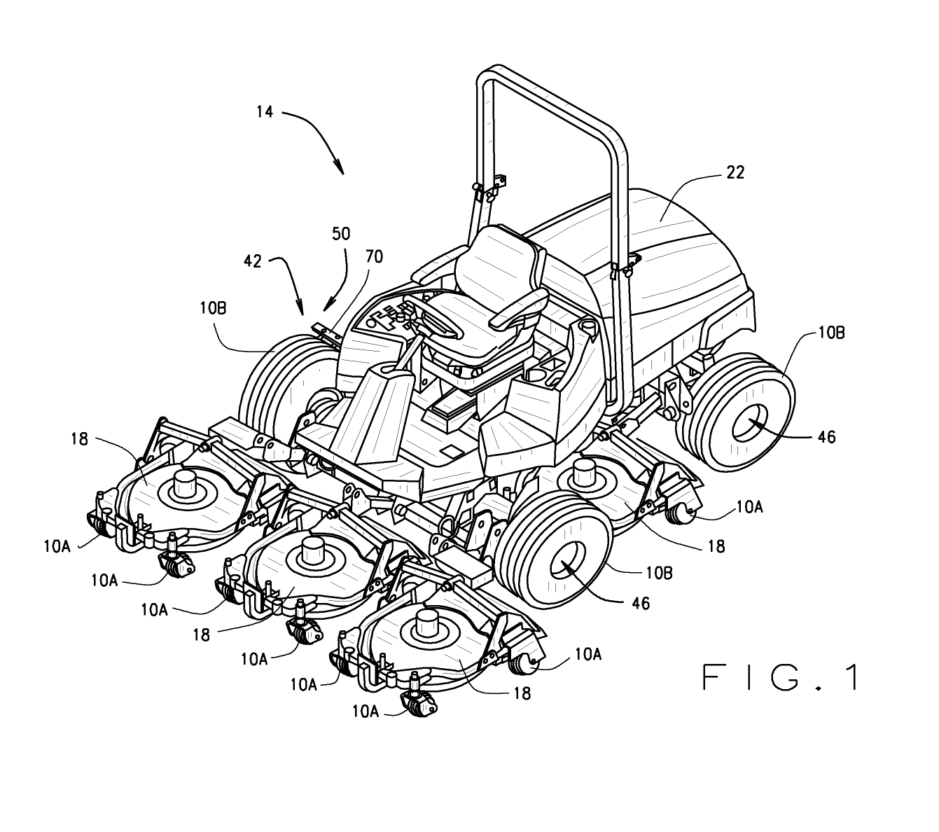

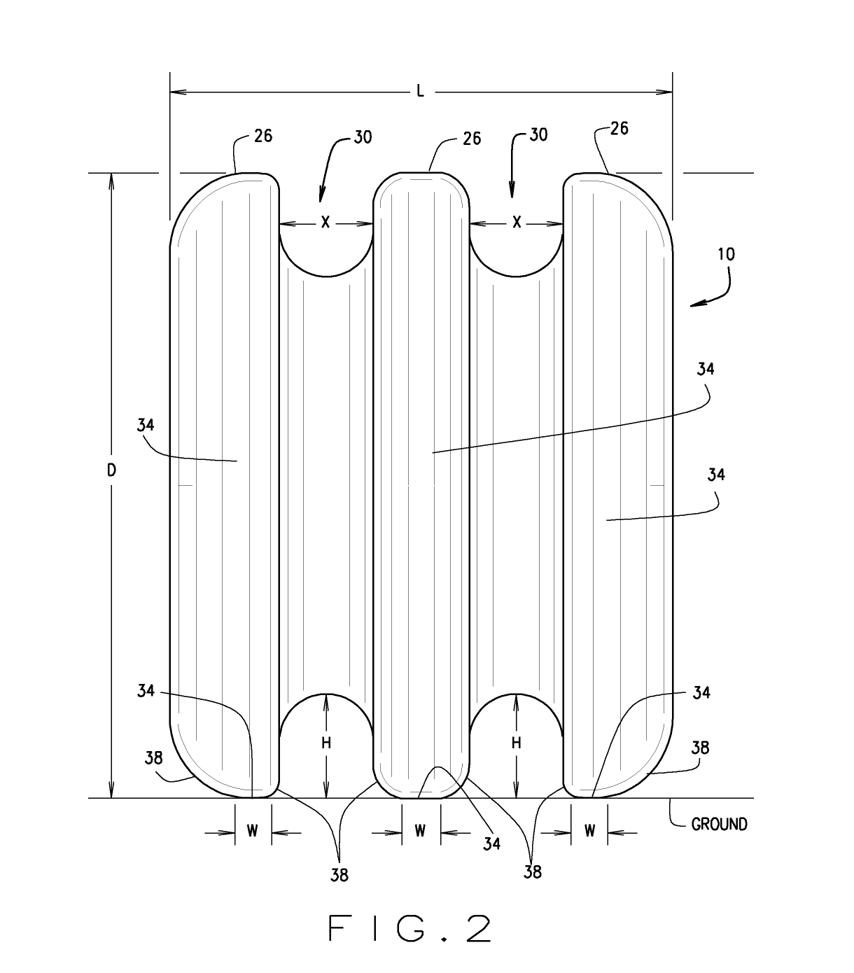

Referring to FIGS. 1 and 2, in various embodiments, the present disclosure provides a controlled contact turf wheel 10 for a turf-care vehicle 14 that is structured and operable to reduce or eliminate such residual uncut/partially cut wheel lines from being created as the turf-care vehicle 14 traverses the ground, i.e., a ground surface with which the controlled contact turf wheel 10 is in contact. As exemplarily shown in FIG. 1, the controlled contact turf wheel 10 can be a non-inflatable, formed, cast or molded wheel 10A, e.g., a wheel of a mower deck 18 of the turf-care vehicle 14, or an inflatable tire 10B, e.g., a traction and/or steering tire of a tractor 22 turf-care vehicle 14. The features and functionality of the non-inflatable, formed, cast or molded wheel embodiment 10A of the controlled contact turf wheel 10 and the inflatable tire embodiment 10B of the controlled contact turf wheel 10 are the same. Therefore, for clarity and simplicity, the non-inflatable, formed, cast or molded wheel embodiment 10A and the inflatable tire embodiment 10B will be comprehensively referred to herein as the controlled contact turf wheel 10.

The turf-care vehicle 14 shown in FIG. 1 is only exemplary and is not limiting. The turf-care vehicle 14 can be any turf-care vehicle used for cutting, grooming and maintaining grass at golf courses, sporting venues, parks, consumer lawns, etc. For example, the turf-care vehicle 14 can be any type or model of turf-care vehicle including, but not limited to, turf-care vehicles having single mower decks with one or more cutting blades, turf-care vehicles having multiple mower decks with one or more cutting blades, and turf-care vehicles including any suitable type or model of respective tractor.

Referring now to FIG. 2, the controlled contact turf wheel 10 comprises a plurality of annular ground contact ribs 26 and a plurality of annular grass passage channels 30 disposed between the ground contact ribs 26. Generally, the ground contact ribs 26 are structured and operable support at least a portion of the weight of the respective mower deck 18 and/or tractor 22 without making noticeable and undesirable lasting impressions in the ground. And, the grass passage channels 30 are structured and operable to allow grass to pass through the channels 30 as the respective wheel 10 rolls across the ground without flattening, compressing or compacting the grass against the ground.

Particularly, each rib 26 comprises an annular face 34 having a width W and a diameter D. A portion of each face 34 will be in contact with the ground as the respective wheel 10 rolls across the ground. The portion of each rib face 34 that is in contact with the ground provides a ground contact surface area that is based on the rib face width W and the diameter D of the respective rib 34. Importantly, the rib face width W and diameter D of each rib 34 are designed to provide a particular ground contact surface for each respective rib 26, and moreover, to provide a particular cumulative ground contact surface area of all the ribs 26 for the wheel 10. Specifically, the wheel 10 is structured to provide a cumulative ground contact surface area that is sufficient to support at least a portion of the weight of the respective a mower deck 18 and/or the tractor 22 to which the wheel 10 is rotationally attached without making an undesirable impression in the ground surface (i.e., making little or no lasting impression in the ground) as the wheel 10 rolls across the ground surface.

More specifically, the wheel 10 is structured such that each rib face 34 has a particular width W and a diameter D that is designed to provide a respective ground contact surface area, whereby the sum of the ground contact surface areas of each rib 26, i.e., the cumulative ground contact surface area, provides sufficient surface area to support at least a portion of the weight of the respective mower deck 18 and/or tractor 22 without making undesirable impressions in the ground surface as the turf-care vehicle 14 traverses the ground. For example, to provide the desired cumulative ground contact surface area, in various embodiments, the sum of the widths W of the faces 34 of all the ribs 26 of the wheel 10 can be equal to approximately 20% to 60% of a total length L of the wheel 10. Generally, each rib 26 of the wheel 10 will have the same diameter D, however, in various embodiments, the width W of each respective rib face 34 can be the same, while in various other embodiments, the width W of at least one of the respective rib faces 34 can be different than the width W of at least one other rib face 34.

In various embodiments, annular edges 38 of each rib 26 can be rounded or beveled to prevent the wheel 10 from scuffing, cutting and/or tearing grass growing from the ground as the turf-care vehicle 14 traverses the ground, particularly during turning maneuvers of the turf-care vehicle 14. In various embodiments, the radius of curvature of the edges 38 for each respective rib 26 can be the same, while in other embodiments the radius of curvature of the edges 38 of at least one of the respective ribs 26 can be different than the radius of curvature of the edges 38 of at least one other ribs 26. In still other embodiments, the radius curvature of opposing edges 38 of the same rib 26 can have different radii of curvature. For example, in various embodiments, the outermost edges 38 of the two outermost ribs 26, i.e., the two outermost opposing edges 38 of the two ribs 26 that are furthest from an longitudinal center of the wheel 10, can have larger radii of curvature than the radii of curvature if the opposing inner edges 38 of the respective ribs 26.

As described above, the grass passage channels 30 are structured and operable to allow grass to pass there through without being pressed to the ground as the respective wheel 10 rolls across the ground. Particularly, each grass passage channel 30 has depth H, relative to the adjacent ribs 26, that is designed to be sufficiently deep to allow the grass to pass there through while providing the structural integrity to the respective wheel 10 necessary to allow the wheel 10 to be used for its intended purpose, i.e., support at least a portion of the weight of the respective mower deck 18 and/or tractor 22. For example, in various embodiments the depth H of the grass passage channels 30 can be ½ inch to 2 inches, or more. Additionally, each grass passage channel 30 has a width X designed to allow a desired amount of grass to pass there through. That is, based on the width X of the grass passage channels 30, portions of grass having an equal width X will be able to pass through the grass passage channels 30 without being flattened, compacted or compressed to the ground. Therefore, it is desirable to have channels 30 having a width X that is as wide as possible while maintaining the structural integrity of the wheel 10 to allow the wheel 10 to be used for its intended purpose. For example, in various embodiments, the sum of the widths X of all the grass passage channels 30 of the wheel 10 can be equal to approximately 30% to 60% of the total length L of the wheel 10. In various embodiments, all the grass passage channels 30 can have the same depth H and/or width X, while in various other embodiments, one or more of the grass passage channels 30 can have a different depth H and/or width X than at least one other grass passage channel 30.

Referring now to FIGS. 1, 2, 3A, 3B, 3C and 4, in various embodiments, the wheel 10, as described above, can be part of a controlled contact turf wheel assembly 42. Generally, the assembly 42 comprises an axle 46 to which the wheel 10 is mounted and a wheel cleaning device 50 structured and operable to prevent debris, e.g., grass clippings, from accumulating in the channels 30 as the wheel 10 rolls across the ground. The wheel cleaning device 50 can be connected to any suitable structure of the wheel assembly 42, the mower deck 18 or the tractor 22.

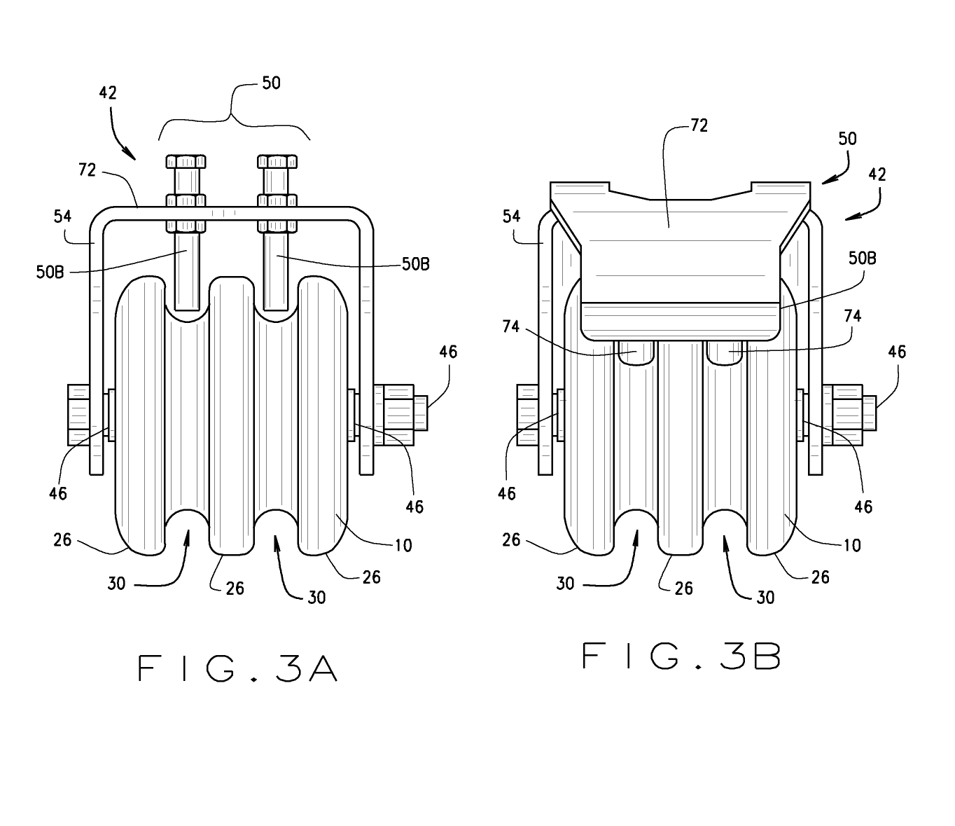

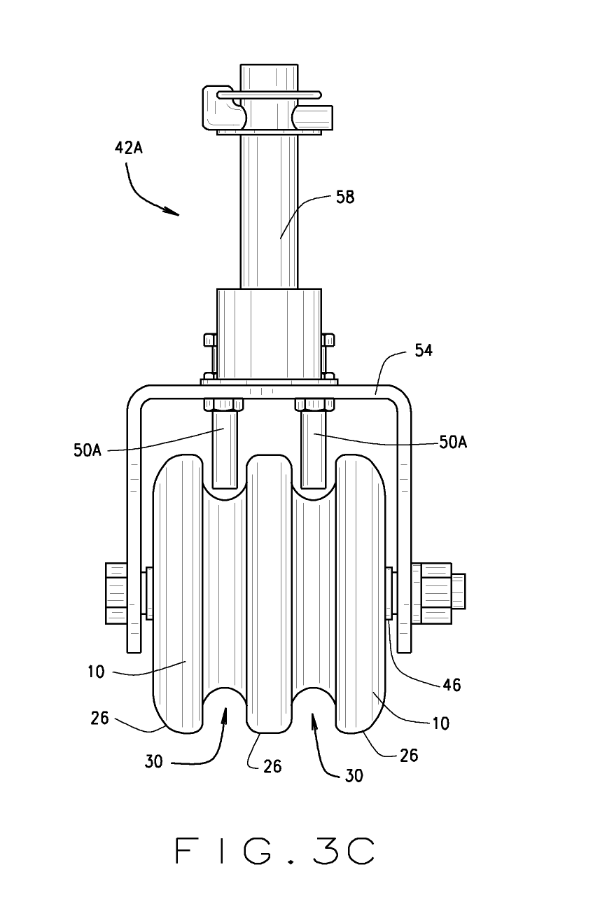

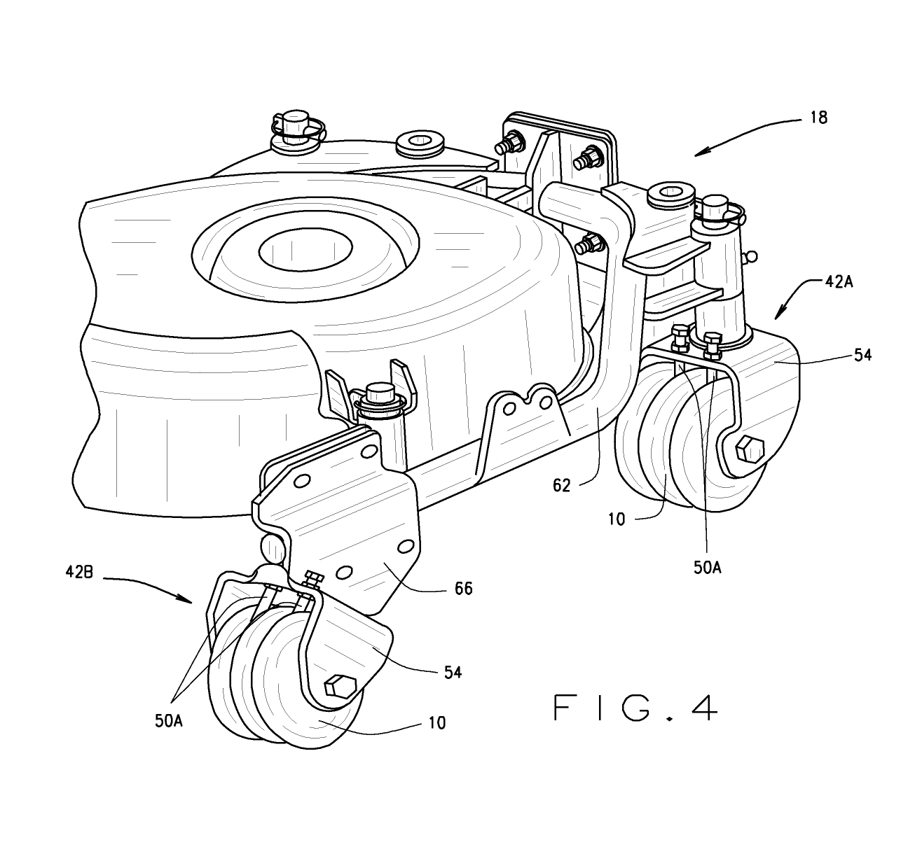

For example, in various embodiments, as exemplarily shown in FIGS. 3A, 3B, 3C and 4, the wheel assembly 42 can include a yoke 54 to which the axle 46 and wheel cleaning device 50 are connected. In various implementations of such embodiments, the wheel assembly 42 can comprise a caster wheel assembly 42A, as exemplarily illustrated in FIGS. 3C and 4, wherein the caster wheel assembly 42A includes a pivot rod 58 extending from the yoke 54. The pivot rod 58 is structured and operable to pivotally mount the caster wheel assembly 42A to a frame 62 of the mower deck 18 (or any other suitable structure of the mower deck 18) of the turf-care vehicle 14. Alternatively, in various other implementations of such embodiments, the wheel assembly 42 can comprise a fixed wheel assembly 42B, as exemplarily shown in FIG. 4, wherein the fixed wheel assembly 42B comprises a mounting bracket 66 that is connected to or forms at least a portion of the yoke 54. The mounting bracket 66 is structured and operable to fixedly mount the fixed wheel 42B assembly to the frame 62 of the mower deck 18 (or any other suitable structure of the mower deck 18) of the turf-care vehicle 14. Although FIG. 4 exemplarily illustrates the mower deck 18 having a caster wheel 42A disposed on the front of the mower deck 18 and a fixed wheel 42B disposed on the back of the mower deck 18, it is envisioned that the caster wheel 42A and the fixed wheel 42B can be disposed on the front of the mower deck 18, the back of the mower deck 18, or both the front and the back of the mower deck 18 to provide and desirable configuration of the mower deck 18.

In various other embodiments, as exemplarily shown in FIG. 1, the cleaning device 50 can be mounted to any suitable structure of the tractor 22.

Referring now to FIGS. 1, 3A and 3C, in various embodiments, the wheel cleaning device 50 can comprise a plurality of clearing pins 50A that extend into a respective one of the channels 30 to remove any debris, e.g., grass, mud and leaves, that may gather in the channels 30. Particularly, as the wheel 10 rolls across the ground, grass clippings, leaves, mud, etc. may stick the wheel 10 and gather in the channels 30. The clearing pins 50A extend into the channels 30 such that debris collected in the channels 30 will be dislodged as the wheel 10 rotates bringing the collected debris into contact with the clearing pins 50A. Accordingly, the clearing pins 50A prevent the debris from accumulating in the channels 30, thereby keeping the channels 30 free of obstructions and allowing the grass to pass through the channels 30 as the wheel 10 rolls across the ground such that the grass is not flattened, compressed or compacted against the ground, as described above.

The clearing pins 50A can be connected to and extend from any suitable structure of the wheel assembly 42, the mower deck 18 or the tractor 22. For example, in various implementations, the clearing pins 50A can be connected to and extend from the yoke 54 of the wheel assembly 42, as illustrated in FIGS. 3A and 3C. Or, in various implementations, the clearing pins 50A can be connected to and extend from a bracket 70 of the wheel assembly 42 that is mounted to a suitable structure of the tractor 22, as illustrated in FIG. 1. The clearing pins 50A can comprise any type of pin, bolt, rod, brush, prong, tine, spike or wire extending from, connected to or integrally formed with the yoke 54 or bracket 70 (or other suitable structure) and suitable for extending into the channels 30 and dislodging any debris that may collect therein.

Referring now to FIG. 3B, in various other embodiments, the wheel cleaning device 50 can comprise a clearing plate 50B including a hood 72 and plurality of channel fingers 74 extending from the hood 72. Each channel finger 74 extends into a respective one of the channels 30 to remove any debris, e.g., grass, mud and leaves, that may gather in the channels 30. The channel fingers 74 extend into the channels 30 such that debris collected in the channels 30 will be dislodged as the wheel 10 rotates bringing the collected debris into contact with the channel fingers 74. Accordingly, the channel fingers 74 prevent the debris from accumulating in the channels 30, thereby keeping the channels 30 free of obstructions and allowing the grass to pass through the channels 30 as the wheel 10 rolls across the ground such that the grass is not flattened, compressed or compacted against the ground, as described above.

The clearing plate 50B can be connected to and extend from any suitable structure of the wheel assembly 42, the mower deck 18 or the tractor 22. For example, in various implementations, the clearing plate 50B can be connected to and extend from the yoke 54 of the wheel assembly 42, as illustrated in FIG. 3B. Or, in various implementations, the clearing plate 50B can be connected to and extend from a bracket of the wheel assembly 42, such as bracket 70 (shown in FIG. 1), that is mounted to a suitable structure of the tractor 22. Additionally, the channel fingers 74 can comprise any type of pin, bolt, rod, brush, prong, tine, spike or wire extending from, connected to or integrally formed with the hood 72 and extending into the channels 30 and dislodging any debris that may collect in the channels 30.

The description herein is merely exemplary in nature and, thus, variations that do not depart from the gist of that which is described are intended to be within the scope of the teachings. Such variations are not to be regarded as a departure from the spirit and scope of the teachings.

1. A controlled contact turf wheel for a turf-care vehicle, said wheel comprising:
a plurality of annular ground contact ribs; and
at least one of annular grass passage channel disposed between the ribs.

2. The wheel of claim 1, wherein each rib comprises an annular face having a width and a diameter structured to provide a cumulative surface area sufficient to support at least a portion of the weight of one of a turf-care vehicle and a mower deck to which the wheel is rotationally attached without making a lasting impression in a ground surface with which the wheel is in contact as the wheel rolls across the ground surface.

3. The wheel of claim 1, wherein the ribs comprise rounded annular edges structured to prevent at least one of cutting and tearing grass from a ground surface with which the wheel is in contact as the wheel rolls across the ground surface.

4. The wheel of claim 1, wherein the at least one channels has a depth structured to allow grass to pass there through without being pressed to a ground surface with which the wheel is in contact as the wheel rolls across the ground surface.

5. A controlled contact turf wheel assembly for a turf-care vehicle, said wheel assembly comprising:
an axle;
a controlled contact turf wheel disposed on the axle, the wheel comprising:
a plurality or annular ground contact ribs; and
at least one annular grass passage channel disposed between the ribs; and
wheel cleaning device structured and operable to prevent debris from accumulating in the at least one channel as the wheel rolls across a ground surface with which the wheel is in contact.

6. The assembly of claim 5, wherein each rib comprises an annular face having a width and a diameter structured to provide a cumulative surface area sufficient to support at least a portion of the weight of one of a turf-care vehicle and a mower deck to which the wheel is rotationally attached without making a lasting impression in a ground surface with which the wheel is in contact as the wheel rolls across the ground surface.

7. The assembly of claim 5, wherein the wheel ribs comprise rounded annular edges structured to prevent at least one of cutting and tearing grass from the ground surface as the wheel rolls across the ground surface.

8. The assembly of claim 5, wherein the at least one wheel channels has a depth structured to allow grass to pass there through without being pressed to the ground surface as the wheel rolls across the ground surface.

9. The assembly of claim 5, wherein the wheel cleaning device comprises at least one clearing pin, each clearing pin extending into a respective one of the at least one channel to prevent the debris from accumulating in the at least one channel.

10. The assembly of claim 5, wherein the wheel cleaning device comprises a cleaning plate including at least one finger, each finger extending into a respective one of the at least one channel to prevent the debris from accumulating in the at least one channel.

11. The assembly of claim 5, wherein the assembly comprises a caster wheel assembly further comprising:
a yoke to which the axle and wheel cleaning device are connected; and
a pivot rod extending from the yoke, the pivot rod structured to pivotally mount the assembly to a mower deck of a turf-care vehicle.

12. The assembly of claim 5, wherein the assembly comprises a fixed wheel assembly comprising a yoke to which the axle and wheel cleaning device are connected, the yoke structured to fixedly mount the assembly to a mower deck a turf-care vehicle.

13. A mower deck for a turf-care vehicle, said mower deck comprising:
a frame; and
at least one controlled contact turf wheel assembly mounted to the frame, said wheel assembly comprising:
an axle;
a controlled contact turf wheel disposed on the axle, the wheel comprising:
a plurality or annular ground contact ribs; and
a plurality of annular grass passage channels disposed between the ribs; and
a wheel cleaning device structured and operable to prevent debris from accumulating in the channels as the wheel rolls across a ground surface with which the wheel is in contact.

14. The mower deck of claim 13, wherein each rib comprises an annular face having a width and a diameter structured to provide a cumulative surface area sufficient to support at least a portion of the weight of one of a turf-care vehicle and a mower deck to which the wheel is rotationally attached without making a lasting impression in a ground surface with which the wheel is in contact as the wheel rolls across the ground surface.

15. The mower deck of claim 13, wherein the wheel ribs comprise rounded annular edges structured to prevent at least one of cutting and tearing grass from the ground surface as the wheel rolls across the ground surface.

16. The mower deck of claim 13, wherein the wheel channels have a depth structured to allow grass to pass there through without being pressed to the ground surface as the wheel rolls across the ground surface.

17. The mower deck of claim 13, wherein the wheel assembly comprises a caster wheel assembly further comprising:
a yoke to which the axle and wheel cleaning device are connected; and
a pivot rod extending from the yoke, the pivot rod structured to pivotally mount the assembly to the frame of the mower deck.

18. The mower of claim 13, wherein the wheel assembly comprises a fixed wheel assembly comprising a yoke to which the axle and wheel cleaning device are connected, the yoke structured to fixedly mount the assembly to the frame of the mower deck.

19. A turf-care vehicle, said vehicle comprising:
a plurality of at least one of traction wheels and steering wheels that are structured and operable to at least one of support the weight of the vehicle during operation of the vehicle and provide motive force to the vehicle such that the vehicle is propelled across a ground surface with which the traction wheels are in contact;
at least one mower deck, each mower deck comprising:
a frame; and
at least one controlled contact turf wheel assembly mounted to the frame, each wheel assembly comprising:
an axle;
a mower deck controlled contact turf wheel disposed on the axle, the mower deck controlled contact turf wheel comprising:
a plurality or annular ground contact ribs; and
a plurality of annular grass passage channels disposed between the ribs; and
a wheel cleaning device structured and operable to prevent debris from accumulating in the channels as the wheel rolls across a ground surface with which the wheel is in contact.

20. The vehicle of claim 19, wherein at least one of the traction wheels comprise a vehicle traction controlled contact turf wheel comprising:
a plurality or annular ground contact ribs; and
a plurality of annular grass passage channels disposed between the ribs.
